(19) United States
(12) Patent Application Publication
(10) Pub. No.: US 2004/0174044 A1
(43) Pub. Date: Sep. 9, 2004

(54) Method for acoustic insulation of a hollow body such as part of a motor vehicle body shell

(76) Inventors: Stephane Nicolier, Vieux Charmont (FR); Philippe Saillet, Valentigney (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/480,595

(22) PCT Filed: Jun. 14, 2002
(86) PCT No.: PCT/FR02/02049

(30) Foreign Application Priority Data
Jun. 15, 2001 (FR) 01/07888

(51) Int. Cl. B62D 29/00

(52) U.S. Cl. 296/181.1

(57) ABSTRACT

The invention relates to a method for acoustic insulation of a hollow body (C), such as part of a motor vehicle body shell, whereby said hollow body is filled with at least one open-celled foam. According to the invention, the filling of at least one part of the body is achieved by pouring flakes of foam (71) into the above. The invention also relates to a body shell (1) of a motor vehicle at least one part of which is filled.

The present invention concerns a method for acoustic insulation of a hollow body.

It concerns more particularly a method for acoustic insulation of a portion of a motor vehicle body shell.

Acoustic insulation has become an important worry in the conception of recent motor vehicles. Thus, many improvements have been provided to the control of noise emitted by the power unit of the vehicle and in particular by the engine. Other improvements have also been provided to the acoustic insulation of noise transmitted by the front unit, i.e., from the zone located between the portion disposed under the engine hood and the passenger compartment of the vehicle. These improvements have let secondary noises reappear, which had been covered previously by the above-mentioned noises. Thus, aerodynamic noises or noises coming from the wheel bearings and propagated through the passenger compartment of the vehicle become a nuisance again for the passengers of the vehicle.

To remedy this drawback, it has been suggested to insert various noise insulating materials in the structure of the vehicle body shell. These materials are generally introduced into the hollow body or bodies of the motor vehicle body shell by the operator during manufacture of the vehicle.

This acoustic insulation of these hollow bodies is sometimes difficult to provide when the shape of the insulating materials used is not adapted to the volume of these hollow bodies and/or the accessibility of the latter is difficult for the operator. Thus, the operator cannot use blocks of foam or wool as commonly used to insulate acoustically other parts of a motor vehicle body shell when the opening cross-section allowing access to the hollow body to be insulated is too small.

To solve this problem, various solutions have already been proposed for the small and medium-size opening cross-sections.

A first solution consists in bagging a traditional insulating foam which has been cut or molded previously, then to compress this bagged foam by creating a vacuum inside, either directly at the time of manufacturing the foam, after the foam has been cut, or at the side of the assembly line of the vehicle body shell. This solution is not satisfactory because it requires the use of costly means to create a vacuum, and besides, the bags used must be of very good quality to prevent them from being torn, and thus the foam from expanding before being mounted in the vehicle body shell.

A second solution consists in using a pressurized foam bomb with diffusion through a nozzle. This solution, on the one hand, is very costly due to the volume of foam required per vehicle to obtain a satisfactory noise insulation, and on the other hand, uses gases noxious to the operator.

Another solution consists in using an inflatable insert in the form of a metallic or plastic support covered by a material that inflates when the motor vehicle body shell passes in an oven. This solution is costly because, on the one hand, the price of the insert is high, and on the other hand, it requires necessarily passing the body shell in an oven.

Another solution, finally, described in the patent EP 0 353 418, consists in using an open-cell polyurethane foam surrounded by a thin layer of closed cells ensuring air-tightness of the foam and whose positioning inside the hollow body is ensured by aspiration of the air contained inside by means of a pump, the foam going back to its original shape when the pump is withdrawn. This solution is also costly because the cost of the foam used and that of the pump are very high. Moreover, the operator must be careful to avoid the risk of piercing the thin layer of closed cells during its introduction in the hollow body constituted by the vehicle body shell, which has cutting edges. Finally, the final position of the foam in the hollow body is largely random, which can be detrimental to the effectiveness of the acoustic insulation.

A goal of the present invention is thus to remedy the above-mentioned drawbacks and to propose a method of acoustic insulation of a hollow body having a narrow or medium-size opening cross-section, which is low-cost, simple to implement, and effective.

To this effect, an object of the invention is a method of acoustic insulation of a hollow body, such as part of a motor vehicle body shell, in which said hollow body is filled with at least an open-cell foam, characterized in that at least a portion of the body is filled by pouring foam flakes into it.

Advantageously, the foam flakes are pieces torn off from a block of foam.

Advantageously also, and before pouring the flakes, they are packaged in a container whose volume is approximately equal to that of the portion of hollow body to be filled.

Preferably, the container is a supple bag.

The invention concerns also a motor vehicle body shell having at least one portion filled according to the above-mentioned method.

Preferably, the filled portion is located around a rear wheel housing of the vehicle body shell.

Other advantages and characteristics of the invention will be better understood by reading the detailed description made in reference to the following figures in which:

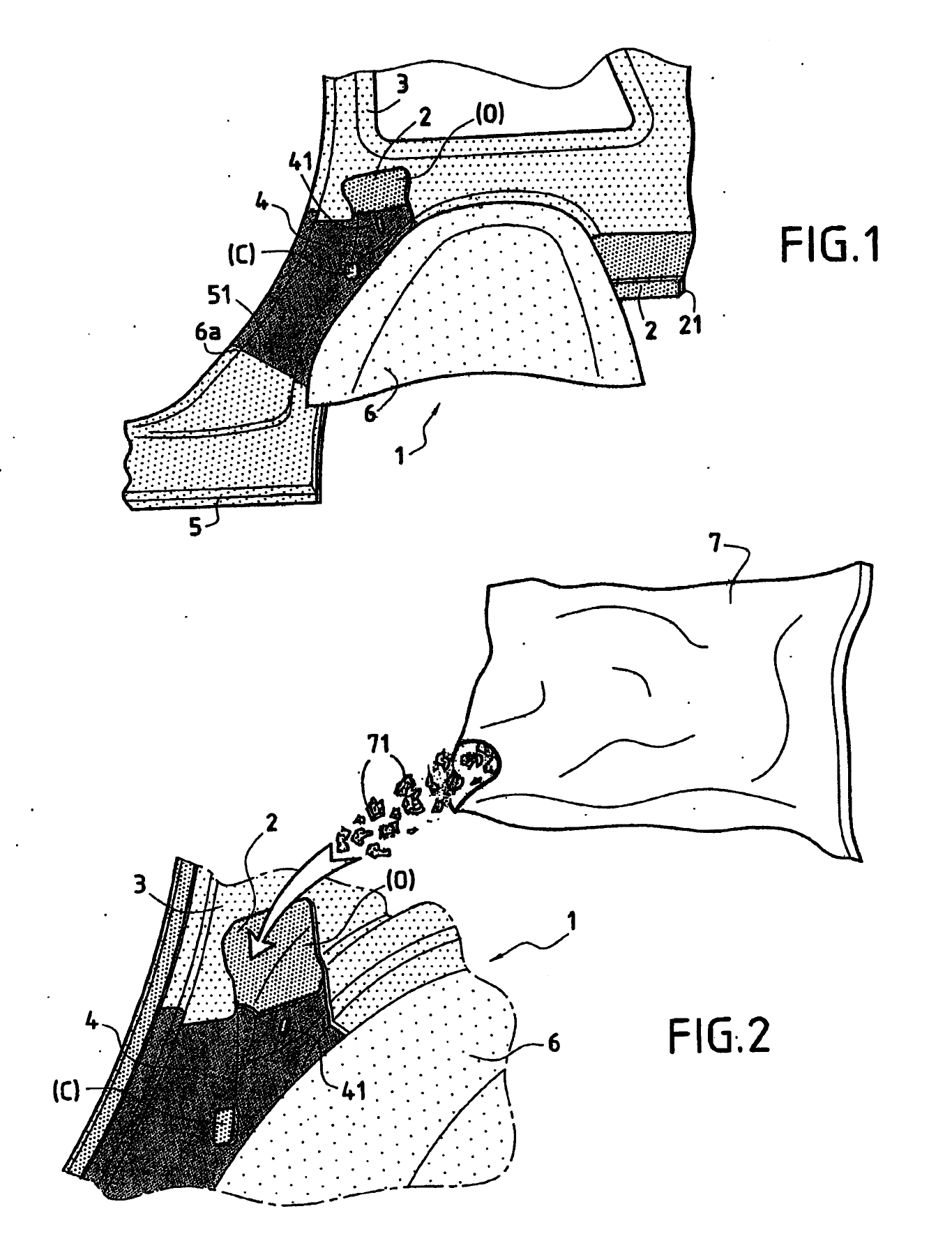

FIG. 1 is a schematic partial view of a rear portion of a motor vehicle body shell according to the invention;

FIG. 2 is an enlarged view of the rear portion of the vehicle body shell filled according to the method of the invention;

FIG. 3 is an enlarged view of foam flakes according to the invention, with which the rear portion is filled.

For clarity, it is specified that the various parts mentioned below are assembled to each other in conventional way, by welding or bolting and that the fixation mode between two particular parts will not be described in more details.

This rear portion of the motor vehicle body shell 1 of the type “station wagon” comprises, in a manner known in itself, in particular a lateral panel side 2 on which are mounted, respectively, an upper rear end liner 3, a lower rear end liner 4, a lateral beam 5, and finally, a wheel housing 6.

A rear fender liner (not shown) is also mounted to the panel side 2 at the upper portion of the wheel housing 6.

The upper rear end liner 3 has at its lower portion a notch 31 on which it is envisioned to fix an inertia reel for a safety belt, not shown, whose support is fixed to the upper portion 41 of the lower rear end liner 4.

This lower rear end liner 4 forms with the lateral panel side 2 a hollow body (C) having an opening (O) defined also, on the one hand, by the rear wheel housing 6 and the rear fender liner, and on the other hand, by the junction 51 with the lateral beam 5.

In order to be able to obtain an acoustic comfort level in the passenger compartment at the rear of the vehicle that is substantially equivalent to that in front, which is acoustically insulated from the outside, it is necessary to prevent aerodynamic noises from the wheel bearings from propagating from the wheel housing 5 into the passenger compartment.

To reach this objective, the operator places and jams first in the portion 21 of the panel side 2, which is free and easily accessible from inside the vehicle body shell, a block of foam having an appropriate size, obtained by molding or cutting, whose characteristics are otherwise known for this application.

Then, the operator places, facing the opening (O), a supple bag 7 filled with foam flakes 71 having a volume approximately equal to the volume of the hollow body (C), as shown on FIG. 2, then pours these same flakes into the hollow body.

The flakes used are clippings from a foam of an alveolary material of the absorbing polyester polyurethane type. Their shape is random and their size is between 8 and 8000 mm³.

Acoustic absorption tests have been performed around the hollow body so as to check whether the acoustic insulation thus obtained was sufficient to prevent noises generated in the rear wheel housing 6 to circulate in the hollow body and thus to be transmitted upward into the passenger compartment.

It has thus been observed that medium as well as high frequencies triggered by the noises were completely absorbed by the flakes according to the invention in all the portions around the wheel housing. Acoustic insulation is thus ensured without requiring positioning control nor occasional repositioning of a block of foam molded according to the complex shape of the hollow body.

The invention that has been described makes it possible, very advantageously, to acoustically insulate a hollow body whose access is very difficult.

In particular, in the case of a portion of a motor vehicle body shell, the operator does not risk harming him- or herself, by introducing his or her hand through the opening whose edges made from the metal sheet as cut are sharp.

Moreover, the implementation of the method is easy and does not require any particular arrangement along the vehicle assembly line.

Finally, the cost of the flakes is extremely low because they come from clippings.

It is self-evident that various variants and improvements can be made without departing from the scope of the invention.

Thus, the bag delivered to the operators to implement the method can be improved to facilitate its prehension and its opening.

Similarly, instead of being packaged in a supple bag, the flakes according to the invention can be poured into the hollow body through means adapted to blow foam pieces.

1. Method for acoustic insulation of a hollow body (C), such as a portion of a motor vehicle body shell, in which said hollow body is filled with at least an open cell foam, characterized in that at least a portion of the body is filled by pouring foam flakes (71) into them.

2. Method according to claim 1, characterized in that the foam flakes are pieces torn off from a foam block.

3. Method according to claim 1 or 2, characterized in that, before pouring the flakes, they are packaged in a container (7) whose volume is approximately equal to that of the hollow body portion to be filled.

4. Method according to claim 3, characterized in that the container is a supple bag (7).

5. Motor vehicle body shell (1) having at least a portion (4) filled according to the method according to any of the preceding claims.

6. Body shell according to claim 6, characterized in that the filled portion is located around a rear wheel housing.
